(19) United States
(12) Patent Application Publication
(10) Pub. No.: US 2023/0418296 A1
(43) Pub. Date: Dec. 28, 2023

(54) AUTONOMOUS MOBILE ROBOT CONTROL SYSTEM AND AUTONOMOUS MOBILE ROBOT CONTROL METHOD

(71) Applicant: TOYOTA JIDOSHA KABUSHIKI KAISHA, Toyota-shi (JP)

(72) Inventors: Yusuke OTA, Nagakute-shi (JP); Shiro ODA, Anjo-shi (JP); Masayoshi TSUCHINAGA, Nisshin-shi (JP); Kei YOSHIKAWA, Nagoya-shi (JP); Takeshi MATSUI, Nisshin-shi (JP)

(73) Assignee: TOYOTA JIDOSHA KABUSHIKI KAISHA, Toyota-shi (JP)

(21) Appl. No.: 18/209,174

(22) Filed: Jun. 13, 2023

(30) Foreign Application Priority Data
Jun. 27, 2022 (JP) 2022-102915

(51) Int. Cl. G05D 1/02; G05D 1/00

(52) U.S. Cl. CPC G05D 1/0214; G05D 1/0088

(57) ABSTRACT

An autonomous mobile robot control system includes: a host management device; and an autonomous mobile robot. The host management device includes a data collection unit that collects sunshine condition data corresponding to a sunshine condition within a movement range of the autonomous mobile robot, and a parameter calculation unit that calculates, based on the sunshine condition data, an optimum parameter that reduces an influence of the sunshine condition corresponding to the sunshine condition data. The autonomous mobile robot includes a parameter setting unit that sets the optimum parameter. The autonomous mobile robot control system executes a predetermined operation based on the optimum parameter set by the parameter setting unit.

### CROSS-REFERENCE TO RELATED APPLICATION

This application claims priority to Japanese Patent Application No. 2022-102915 filed on Jun. 27, 2022, incorporated herein by reference in its entirety.

### BACKGROUND

### 1. Technical Field

The present disclosure relates to an autonomous mobile robot control system and an autonomous mobile robot control method.

### 2. Description of Related Art

An autonomous mobile robot that autonomously moves to a destination while avoiding obstacles within a given facility has been proposed (see, for example, Japanese Unexamined Patent Application Publication No. 2018-156243 (JP 2018-156243 A)). This autonomous mobile robot is provided with a sensor device (for example, a laser sensor for detecting obstacles or a camera as a recognition sensor).

### SUMMARY

However, in JP 2018-156243 A, there is a problem that detection variations of the sensor device increases depending on the sunshine conditions within the movement range of the autonomous mobile robot, and as a result, it may become difficult to travel autonomously.

The present disclosure has been made to solve such a problem, and provides an autonomous mobile robot control system and an autonomous mobile robot control method capable of suppressing an increase in detection variations of a sensor device provided in an autonomous mobile robot due to sunshine conditions within the movement range of the autonomous mobile robot.

An autonomous mobile robot control system according to the present disclosure includes: a host management device; and an autonomous mobile robot. The host management device includes a data collection unit that collects sunshine condition data corresponding to a sunshine condition within a movement range of the autonomous mobile robot, a parameter calculation unit that calculates, based on the sunshine condition data, an optimum parameter that reduces an influence of the sunshine condition corresponding to the sunshine condition data, and a communication unit that transmits the optimum parameter to the autonomous mobile robot. The autonomous mobile robot includes a communication unit that receives the optimum parameter, and a parameter setting unit that sets the optimum parameter. The autonomous mobile robot control system executes a predetermined operation based on the optimum parameter set by the parameter setting unit.

With such a configuration, detection variations of the sensor device (for example, the visible camera, the depth camera, and the laser sensor) provided in the autonomous mobile robot can be suppressed from increasing due to the sunshine condition within the movement range of the autonomous mobile robot.

This is because the autonomous mobile robot control system is provided with the parameter calculation unit (the learning model) that calculates, based on the sunshine condition data, optimum parameters that reduce the influence of the sunshine condition corresponding to the sunshine condition data, and the autonomous mobile robot executes the predetermined operation based on the optimum parameters.

The above autonomous mobile robot control system may further include a plurality of environmental cameras that captures images of the movement range of the autonomous mobile robot and transmits the captured images to the host management device. The sunshine condition data may include the images.

In the above autonomous mobile robot control system, the sunshine condition data may further include date and time, time zone, weather, and temperature.

In the above autonomous mobile robot control system, the autonomous mobile robot may include a visible camera that captures an image of surroundings. The optimum parameter may be at least one of exposure time and shutter interval. The predetermined operation may be an operation of capturing the image of the surroundings with the visible camera based on the optimum parameter set by the parameter setting unit.

In the above autonomous mobile robot control system, the autonomous mobile robot may include a distance sensor. The optimum parameter may be a parameter of a filter that executes noise canceling processing on sensor data that is an output of the distance sensor. The predetermined operation may be an operation of executing the noise canceling processing on the sensor data that is the output of the distance sensor based on the optimum parameter set by the parameter setting unit.

In the above autonomous mobile robot control system, the distance sensor may be a depth camera or a laser sensor.

In the above autonomous mobile robot control system, the parameter calculation unit may calculate the optimum parameter for each of a plurality of routes along which the autonomous mobile robot moves. The parameter setting unit may set, when the autonomous mobile robot approaches one of the routes, the optimum parameter corresponding to the route.

In the above autonomous mobile robot control system, the parameter calculation unit may be a learning model generated by a learning engine.

The present disclosure can provide an autonomous mobile robot control system and an autonomous mobile robot control method capable of suppressing an increase in detection variations of a sensor device provided in an autonomous mobile robot due to a sunshine condition within the movement range of the autonomous mobile robot.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram of an autonomous mobile robot control system according to a first embodiment;

FIG. 2 is a schematic diagram of an autonomous mobile robot according to the first embodiment;

FIG. 3 is a diagram illustrating examples of situations that pose problems that occur in the operation of the autonomous mobile robot according to the first embodiment and workarounds for the situations;

FIG. 4 is a flowchart illustrating the operation of the autonomous mobile robot control system according to the first embodiment;

FIG. 5 is a flowchart illustrating the detailed operation of a security process of the autonomous mobile robot control system according to the first embodiment;

FIG. 6 is a flowchart illustrating the detailed operation of an operation efficiency process of the autonomous mobile robot control system according to the first embodiment;

FIG. 7 is a schematic configuration diagram of an autonomous mobile robot control system 1A;

FIG. 8 is a schematic diagram illustrating an operation example of a learning engine 50;

FIG. 9 is an example of a route along which an autonomous mobile robot 20 moves;

FIG. 10 is an example of an optimum parameter for each route; and

FIG. 11 is a flowchart of an operation example of the autonomous mobile robot control system 1A.

### DETAILED DESCRIPTION OF EMBODIMENTS

In order to clarify the explanation, the following description and drawings have been omitted or simplified as appropriate. Each element described in the drawing as a functional block that performs various processes can be configured with a central processing unit (CPU), a memory, and other circuits in terms of hardware, and can be realized by a program or the like loaded into a memory in terms of software. Therefore, those skilled in the art will understand that these functional blocks can be realized in various forms by hardware alone, software alone, or a combination thereof, and are not limited to either. In each drawing, the same elements are designated by the same reference signs, and duplicate explanations are omitted as necessary.

The program described above is stored using various types of non-transitory computer-readable media, and can be supplied to a computer. The non-transitory computer-readable media include various types of tangible recording media (storage media). Examples of the non-transitory computer-readable media include a magnetic recording media (for example, a flexible disc, a magnetic tape, a hard disk drive), a magneto-optical recording media (for example, a magneto-optical disc), a CD-ROM (read only memory), a CD-R, a CD-R/W, and a semiconductor memory (for example, a mask ROM, a programmable ROM (PROM), an erasable PROM (EPROM), a flash ROM, a random access memory (RAM)). Further, the program may also be supplied to the computer by various types of transitory computer-readable media. Examples of the transitory computer-readable media include electrical signals, optical signals, and electromagnetic waves. The transitory computer-readable media can supply the program to the computer via a wired communication path such as an electric wire and an optical fiber, or a wireless communication path.

Although a hospital is assumed below as an example of a facility to which the autonomous mobile robot control system is applied, the autonomous mobile robot control system can be used in various facilities other than hospitals.

### First Embodiment

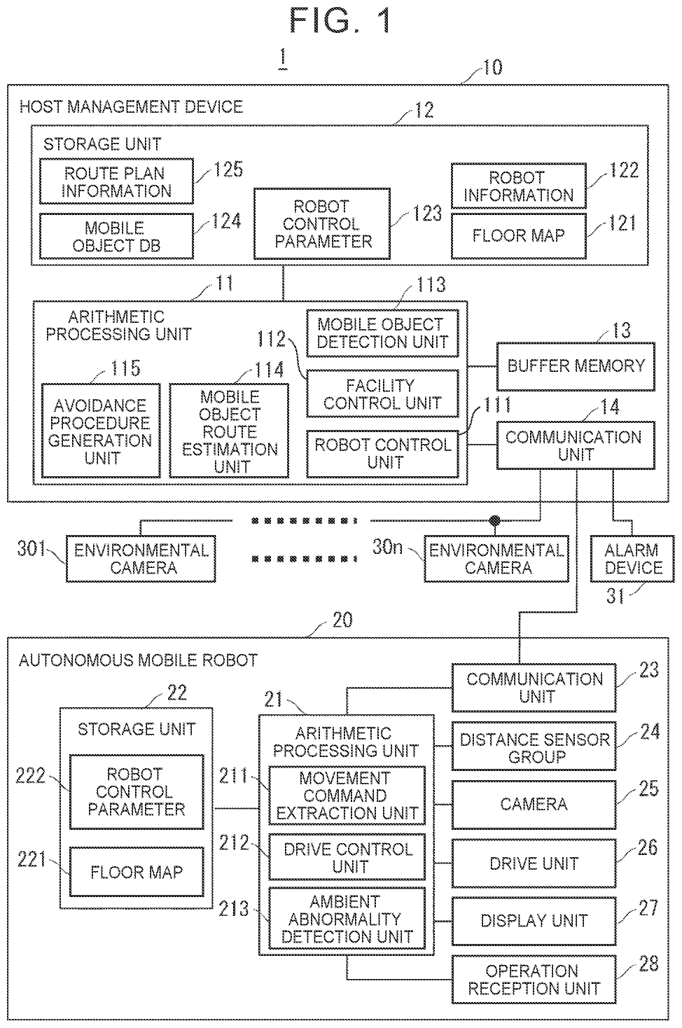

First, FIG. 1 shows a block diagram of an autonomous mobile robot control system 1 according to the first embodiment. As shown in FIG. 1, the autonomous mobile robot control system 1 according to the first embodiment has a host management device 10, an autonomous mobile robot (for example, an autonomous mobile robot 20), environmental cameras 301 to 30n, and an alarm device 31. Although one autonomous mobile robot 20 is shown in FIG. 1, it is assumed that a plurality of autonomous mobile robots 20 is provided. The autonomous mobile robot control system 1 efficiently controls the autonomous mobile robots 20 while causing the autonomous mobile robots 20 to autonomously move in a predetermined facility. Therefore, in the autonomous mobile robot control system 1, the plurality of environmental cameras 301 to 30n is installed in the facility to acquire images of the range in which the autonomous mobile robot 20 moves. In the autonomous mobile robot control system 1, the images acquired by the environmental cameras 301 to 30n are collected by the host management device 10. Also, in the autonomous mobile robot control system 1, by providing the alarm device 31, a message necessary for the operation of the autonomous mobile robot 20 is notified to facility users whose action control cannot be directly performed by the system.

In the autonomous mobile robot control system 1 according to the first embodiment, the host management device 10 creates a route to the destination of the autonomous mobile robot 20 based on route plan information, and instructs the destination according to the route plan to the autonomous mobile robot 20. Then, the autonomous mobile robot 20 autonomously moves toward the destination designated by the host management device 10. At this time, in the autonomous mobile robot control system 1 according to the first embodiment, the autonomous mobile robot 20 autonomously moves toward the destination using sensors, a floor map, positional information, etc. provided in itself.

The host management device 10 uses the environmental cameras 301 to 30n to suppress a decrease in the operation efficiency caused by facing or crossing each other in relation between the facility user and the autonomous mobile robot 20, between the autonomous mobile robot 20 and a carrier, and between the autonomous mobile robot 20 and the autonomous mobile robot 20 to suppress the operation of the autonomous mobile robot 20 from interfering with the actions of the facility users. The autonomous mobile robot control system 1 also has a function of suppressing unauthorized persons from entering a security area where entry is restricted (for example, a dispensing room, an intensive care unit, and a staff waiting area in a hospital).

The host management device 10 includes an arithmetic processing unit 11, a storage unit 12, a buffer memory 13, and a communication unit 14. The arithmetic processing unit 11 that performs calculations for controlling and managing the autonomous mobile robot 20 can be implemented as a device that executes a program, such as a CPU of a computer. Various functions can also be realized by the program. In FIG. 1, only a robot control unit 111, a facility control unit 112, a mobile object detection unit 113, a mobile object route estimation unit 114, and an avoidance procedure generation unit 115, which are characteristic of the arithmetic processing unit 11, are shown, but other processing blocks are also provided.

The robot control unit 111 performs calculations for remotely operating the autonomous mobile robot 20 and generates specific operation instructions for the autonomous mobile robot 20. Based on avoidance procedure information generated by the avoidance procedure generation unit 115, the facility control unit 112 controls the alarm device 31 or permission/non-permission of opening/closing of a door (not shown). Here, a plurality of the alarm devices 31 is provided in the facility. The alarm device 31 uses voice or text information to notify facility users of an alarm such as the passage of the autonomous mobile robot 20.

The mobile object detection unit 113 detects a mobile object from image information acquired using the environmental cameras 301 to 30n. The mobile object detected by the mobile object detection unit 113 is, for example, the autonomous mobile robot 20, a carrier that transports objects, a priority carrier designated for preferential movement (for example, a stretcher), and persons and objects that move within facilities such as persons.

The mobile object route estimation unit 114 estimates movement routes of a plurality of mobile objects ahead of the present time based on the characteristics of each of the mobile objects detected by the mobile object detection unit 113. More specifically, the mobile object route estimation unit 114 refers to a mobile object database 124 in the storage unit 12 to specify the type of the mobile object, such as whether the mobile object is a person or the autonomous mobile robot 20. The mobile object route estimation unit 114 refers to route plan information 125 to estimate the movement route of the autonomous mobile robot 20. The mobile object route estimation unit 114 estimates the movement route of the mobile object other than the autonomous mobile robot 20 according to the past action history and the type of the mobile object.

The avoidance procedure generation unit 115 sets, among the mobile objects, multiple mobile objects whose movement routes overlap each other as avoidance processing target mobile objects, based on the movement routes estimated by the mobile object route estimation unit 114. In addition, the avoidance procedure generation unit 115 generates an avoidance procedure that does not interfere with each other's movements for the avoidance process target mobile objects. A specific example of the avoidance procedure and details of the processing performed by the arithmetic processing unit 11 will be described later.

The storage unit 12 is a storage unit that stores information necessary for managing and controlling the robot. In the example of FIG. 1, a floor map 121, robot information 122, a robot control parameter 123, the mobile object database 124, and the route plan information 125 are shown, but the information stored in the storage unit 12 may include other information. The arithmetic processing unit 11 performs calculations using the information stored in the storage unit 12 when performing various processes.

The floor map 121 is map information of a facility in which the autonomous mobile robot 20 moves. The floor map 121 may be created in advance, may be generated from information obtained from the autonomous mobile robot 20, or may be information obtained by adding map correction information that is generated from information obtained from the autonomous mobile robot 20, to a basic map created in advance.

The robot information 122 indicates the model number, specifications, and the like of the autonomous mobile robot 20 managed by the host management device 10. The robot control parameter 123 indicates control parameters such as distance threshold information between obstacles and each of the autonomous mobile robot 20 managed by the host management device 10. The robot control unit 111 uses the robot information 122, the robot control parameter 123, and the route plan information 125 to give specific operation instructions to the autonomous mobile robot 20.

The buffer memory 13 is a memory that stores intermediate information generated in the processing of the arithmetic processing unit 11. The communication unit 14 is a communication interface for communicating with the environmental cameras 301 to 30n, the alarm device 31, and at least one autonomous mobile robot 20 provided in the facility where the autonomous mobile robot control system 1 is used. The communication unit 14 can perform both wired communication and wireless communication.

The autonomous mobile robot 20 includes an arithmetic processing unit 21, a storage unit 22, a communication unit 23, a proximity sensor (for example, a distance sensor group 24), a camera (visible camera) 25, a drive unit 26, a display unit 27, and an operation reception unit 28. Although FIG. 1 shows only typical processing blocks provided in the autonomous mobile robot 20, the autonomous mobile robot 20 also includes many other processing blocks that are not shown.

The communication unit 23 is a communication interface for communicating with the communication unit 14 of the host management device 10. The communication unit 23 communicates with the communication unit 14 using, for example, a wireless signal. The distance sensor group 24 is, for example, a proximity sensor, and outputs proximity object distance information indicating a distance from an object or a person that is present around the autonomous mobile robot 20. The camera 25, for example, captures an image for grasping the surrounding situation of the autonomous mobile robot 20. The camera 25 can also capture an image of a position marker provided on the ceiling or the like of the facility, for example. In the autonomous mobile robot control system 1 according to the first embodiment, the autonomous mobile robot 20 uses the position marker to grasp its own position. The drive unit 26 drives drive wheels provided on the autonomous mobile robot 20. The display unit 27 displays a user interface screen that serves as the operation reception unit 28. Further, the display unit 27 may display information indicating the destination of the autonomous mobile robot 20 and the state of the autonomous mobile robot 20. The operation reception unit 28 includes various switches provided on the autonomous mobile robot 20 in addition to the user interface screen displayed on the display unit 27. These various switches include, for example, an emergency stop button.

The arithmetic processing unit 21 performs calculations used for controlling the autonomous mobile robot 20. More specifically, the arithmetic processing unit 21 has a movement command extraction unit 211, a drive control unit 212, and an ambient abnormality detection unit 213. Although FIG. 1 shows only typical processing blocks included in the arithmetic processing unit 21, the arithmetic processing unit 21 includes processing blocks that are not shown.

The movement command extraction unit 211 extracts a movement command from the control signal given from the host management device 10 and gives it to the drive control unit 212. The drive control unit 212 controls the drive unit 26 to move the autonomous mobile robot 20 at the speed and direction indicated by the movement command given from the movement command extraction unit 211. When receiving an emergency stop signal from an emergency stop button included in the operation reception unit 28, the drive control unit 212 stops the operation of the autonomous mobile robot 20 and gives an instruction to the drive unit 26 so that drive force is not generated. The ambient abnormality detection unit 213 detects an abnormality that has occurred around the autonomous mobile robot 20 based on information obtained from the distance sensor group 24 and the like, and gives a stop signal to the drive control unit 212 to stop the autonomous mobile robot 20. The drive control unit 212 that has received the stop signal instructs the drive unit 26 so that the drive force is not generated.

The storage unit 22 stores a floor map 221 and a robot control parameter 222. FIG. 1 shows part of the information stored in the storage unit 22, and information other than the floor map 221 and the robot control parameter 222 shown in FIG. 1 is also included. The floor map 221 is map information of the facility in which the autonomous mobile robot 20 moves. This floor map 221 is, for example, a download of the floor map 121 of the host management device 10. Note that the floor map 221 may be created in advance. The robot control parameter 222 is a parameter for operating the autonomous mobile robot 20, and includes, for example, an operation limit threshold value for stopping or limiting the operation of the autonomous mobile robot 20 in the distance from an obstacle or a person.

The drive control unit 212 refers to the robot control parameter 222 and stops the operation or limits the operation speed in response to the fact that the distance indicated by the distance information obtained from the distance sensor group 24 has fallen below the operation limit threshold value.

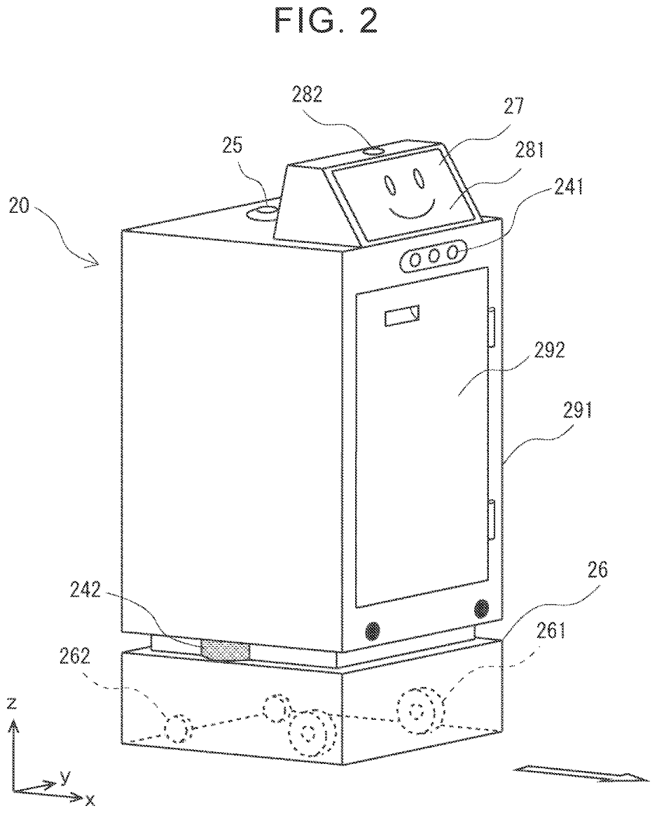

Here, the appearance of the autonomous mobile robot 20 will be described. FIG. 2 shows a schematic diagram of the autonomous mobile robot 20 according to the first embodiment. The autonomous mobile robot 20 shown in FIG. 2 is one of the modes of the autonomous mobile robot 20, and may be in another form.

The example shown in FIG. 2 is an autonomous mobile robot 20 having a storage 291 and a door 292 that seals the storage 291. The autonomous mobile robot 20 moves autonomously to transport a stored object stored in the storage 291 to the destination instructed by the host management device 10. In FIG. 2, the x direction shown in FIG. 2 is the forward and backward directions of the autonomous mobile robot 20, the y direction is the right-left direction of the autonomous mobile robot 20, and the z direction is the height direction of the autonomous mobile robot 20.

As shown in FIG. 2, front-rear distance sensors 241 and right-left distance sensors 242 are provided as the distance sensor group 24 on the exterior of the autonomous mobile robot 20 of the first embodiment. The autonomous mobile robot 20 of the first embodiment measures the distance of objects or persons in the front-rear direction of the autonomous mobile robot 20 by the front-rear distance sensors 241. The autonomous mobile robot 20 of the first embodiment also measures the distance of the objects and persons in the right-left direction of the autonomous mobile robot 20 by the right-left distance sensors 242.

In the autonomous mobile robot 20 according to the first embodiment, the drive unit 26 is provided below the storage 291. The drive unit 26 is provided with drive wheels 261 and casters 262. The drive wheels 261 are wheels for moving the autonomous mobile robot 20 frontward, rearward, rightward, and leftward. The casters 262 are driven wheels that roll following the drive wheels 261 without being given a drive force.

Further, in the autonomous mobile robot 20, the display unit 27, an operation interface 281, and the camera 25 are provided on the upper surface of the storage 291. The operation interface 281 is displayed on the display unit 27 as the operation reception unit 28. An emergency stop button 282 is provided on the upper surface of the display unit 27.

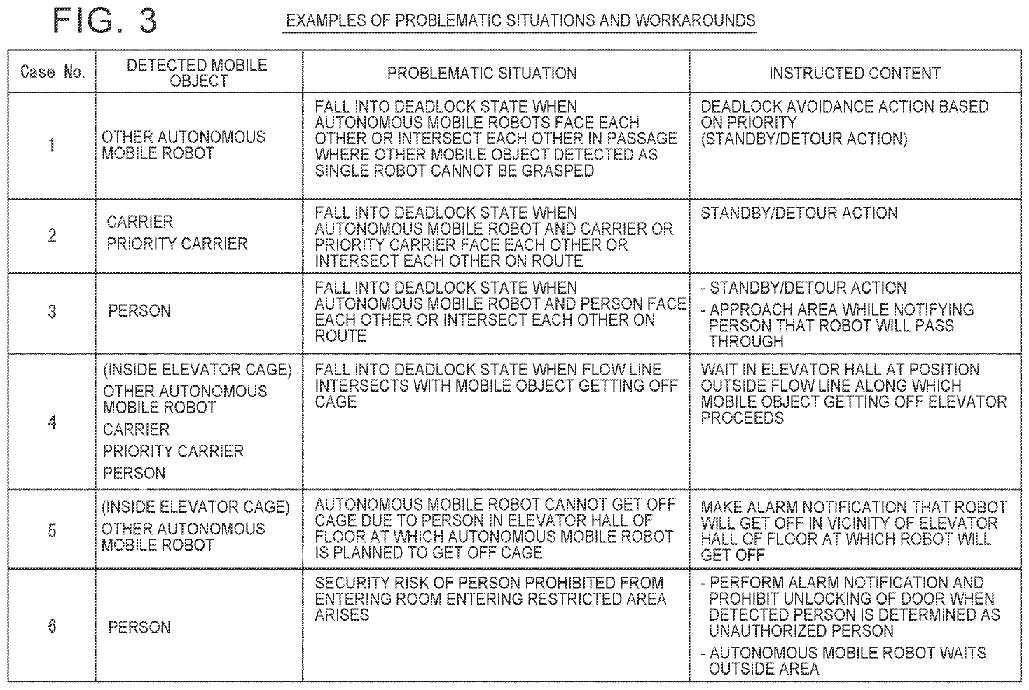

Next, the operation of the autonomous mobile robot control system 1 according to the first embodiment will be explained. In the autonomous mobile robot control system 1 according to the first embodiment, the movement of a mobile object such as a person and the autonomous mobile robot 20 in the facility where the autonomous mobile robot 20 is operated is estimated, and the autonomous mobile robot 20 is controlled to avoid a situation that causes a decrease in operation efficiency of the autonomous mobile robot 20 from the estimated movement route. The autonomous mobile robot control system 1 also has a function of suppressing unauthorized persons from entering the security area of the facility in addition to improving the operation efficiency of the autonomous mobile robot 20. With reference to FIG. 3, a situation in which a problem occurs in the autonomous mobile robot control system 1 and a method of avoiding the problem will be described. FIG. 3 is a diagram illustrating examples of situations that pose problems that occur in the operation of the autonomous mobile robot according to the first embodiment and workarounds for the situations.

FIG. 3 shows six examples of situations in which problems occur. A first example occurs when the movement routes of the autonomous mobile robots 20 overlap. In this first example, the autonomous mobile robots 20 face each other in one passage, or the movement routes of the autonomous mobile robots 20 intersect at a corner or at an intersection of passages. When a situation such as this first example occurs, the autonomous mobile robots 20 stop moving at a safe distance from each other by means of sensors provided in themselves. However, this stop state is not canceled unless an avoidance action is given in some way, and a deadlock state occurs in which the operation of the autonomous mobile robot 20 stops unless an avoidance action is separately prepared.

In order to suppress the occurrence of such a deadlock state, the autonomous mobile robot control system 1 instructs the autonomous mobile robot 20 to take a deadlock avoidance action that cause one autonomous mobile robot 20 to wait until the other autonomous mobile robot 20 passes based on the priority assigned to each autonomous mobile robot 20.

For example, the higher the urgency of the load mounted on the autonomous mobile robot 20, the higher the priority, and the priority is set high when the autonomous mobile robot 20 is proceeding on the forward route. The method of determining the priority is not limited to this, and can be set to any priority in consideration of the circumstances of the facility to which the autonomous mobile robot control system 1 is applied.

A second example is a case where the movement routes of the autonomous mobile robot 20 and the carrier or the priority carrier face each other or intersect each other in the passage of the facility. The carrier or the priority carrier is pushed by a person or carried by an autonomous mobile robot. The carrier or the priority carrier may be parked in aisles within the facility. When such a carrier or a priority carrier passes through, the autonomous mobile robot 20 may be put into an emergency stop state by button operation by a facility staff member or the like. Since a human operation is required to cancel the emergency stop state, the autonomous mobile robot 20 may fall into a deadlock state. The carrier or the priority carrier is often considered to have a higher priority than the autonomous mobile robot 20, and situations in which the autonomous mobile robot 20 interferes with these traffic should be avoided.

Therefore, when a situation like the second example occurs, the autonomous mobile robot control system 1 instructs the autonomous mobile robot 20 to wait until the carrier or the priority carrier passes through, or to take a detour action to change the movement route. As a result, the autonomous mobile robot control system 1 suppresses a decrease in the operation efficiency of the autonomous mobile robot 20 when the problem of the second example occurs.

A third example is a case where a person and the autonomous mobile robot 20 face each other or intersect each other on the movement route of the autonomous mobile robot 20. The autonomous mobile robot 20 is programmed to stop when a certain distance (for example, a safety distance) from a person cannot be maintained by a sensor provided on the robot itself. Therefore, for example, when the autonomous mobile robot 20 passes through an area crowded with people, the autonomous mobile robot 20 stops in the crowd because the safety distance cannot be secured, and a deadlock state occurs in which the autonomous mobile robot 20 cannot move until the congestion is resolved.

In order to eliminate such a deadlock, the autonomous mobile robot control system 1 instructs the autonomous mobile robot 20 to wait before entering an area with a high degree of human congestion or to pass through a route that avoids an area with a high degree of human congestion. In addition, when the degree of human congestion is low, the autonomous mobile robot control system 1 instructs the autonomous mobile robot 20 to pass through the area with low human congestion while notifying persons that the autonomous mobile robot 20 will pass through the area by voice or text information. This notification may be made using the alarm device 31, or may be made using a reporting device (not shown in FIG. 2) provided in the autonomous mobile robot 20.

A fourth example is a case where any of another autonomous mobile robot 20, a carrier, a priority carrier, or a person is present in the cage of the elevator to be boarded. In such a case, if the route for the person or the autonomous mobile robot 20 to get off the elevator and the route for the autonomous mobile robot 20 waiting in the elevator hall to get into the elevator coincide with each other, a state occurs in which there is no space to evacuate in the cage of the elevator or there is no space to get off the elevator. When such a state occurs, not only the deadlock state occurs to the autonomous mobile robot 20, but also the user of the elevator cannot get off the elevator.

Therefore, in the fourth example, the autonomous mobile robot control system 1 instructs the autonomous mobile robot 20 to wait in the elevator hall in a space outside the movement route (flow line) along which the person or the autonomous mobile robot 20 getting off the elevator proceeds.

A fifth example is an example in which, when the autonomous mobile robot 20 in the cage of the elevator gets off the cage and there is a person in the elevator hall, the autonomous mobile robot 20 cannot get off the cage due to the person in the elevator hall.

In this fifth example, the autonomous mobile robot control system 1 notifies the person near the elevator hall in advance that the autonomous mobile robot 20 will get off, via the alarm device 31 installed near the elevator hall.

A sixth example is an example in which a security risk arises when an unauthorized person who is prohibited from entering the security area accompanies the autonomous mobile robot 20 and enters the security area. In this sixth example, when a person accompanying the autonomous mobile robot 20 is detected as a mobile object, the autonomous mobile robot control system 1 refers to security information for the detected person, performs an alarm notification via the alarm device 31, and prohibits unlocking of the door of the security area. The autonomous mobile robot control system 1 also causes the autonomous mobile robot 20 to wait outside the security area when a security risk according to the sixth example occurs.

The situations in which the above problems occur are examples of a phenomenon that reduces the operation efficiency of the autonomous mobile robot 20 in the facility. The autonomous mobile robot control system 1 according to the first embodiment generates procedures to avoid problems according to the mode of the mobile object such as the detected mobile object and the location where the mobile object is detected, also for situations in which problems other than the above occur. Based on the generated avoidance procedure, the autonomous mobile robot control system 1 instructs the autonomous mobile robot 20 to perform avoidance actions such as standby, detour, and alarm notification.

Here, the operation of the autonomous mobile robot control system 1 according to the first embodiment will be explained in detail. In the following description, processes related to generation of an avoidance procedure in the autonomous mobile robot control system 1 according to the first embodiment will be described in particular. However, the autonomous mobile robot control system 1 according to the first embodiment also performs other required processes. The content of the avoidance procedure generated by the autonomous mobile robot control system 1 according to the first embodiment is appropriately changed according to the situation in which the problem occurs, regardless of the procedure shown in FIG. 3.

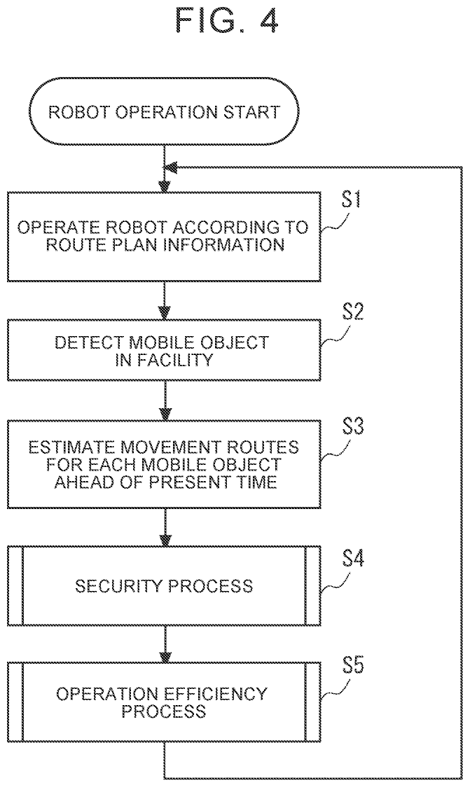

FIG. 4 shows a flowchart illustrating the operation of the autonomous mobile robot control system according to the first embodiment. As shown in FIG. 4, the autonomous mobile robot control system 1 according to the first embodiment operates the autonomous mobile robot 20 according to the route plan information 125 (step S1). Subsequently, the autonomous mobile robot control system 1 acquires the image information in the facility using the environmental cameras 301 to 30n, and the mobile object detection unit 113 detects the mobile object in the facility based on the acquired image information (step S2). Then, the autonomous mobile robot control system 1 uses the mobile object route estimation unit 114 to estimate the movement routes of the plurality of mobile objects based on the characteristics of each of the mobile objects detected by the mobile object detection unit 113 (step S3). Thereafter, the autonomous mobile robot control system 1 performs a security process (step S4) and an operation efficiency process (step S5). Either the security process or the operation efficiency process may be performed first.

The security process is, for example, a process for suppressing unauthorized persons from entering the security area described in the sixth example of FIG. 3. The operation efficiency process is a process for suppressing a decrease in the operation efficiency such as deadlock avoidance described in the first to fifth examples of FIG. 3. Each of the security process and the operation efficiency process will be described in detail below.

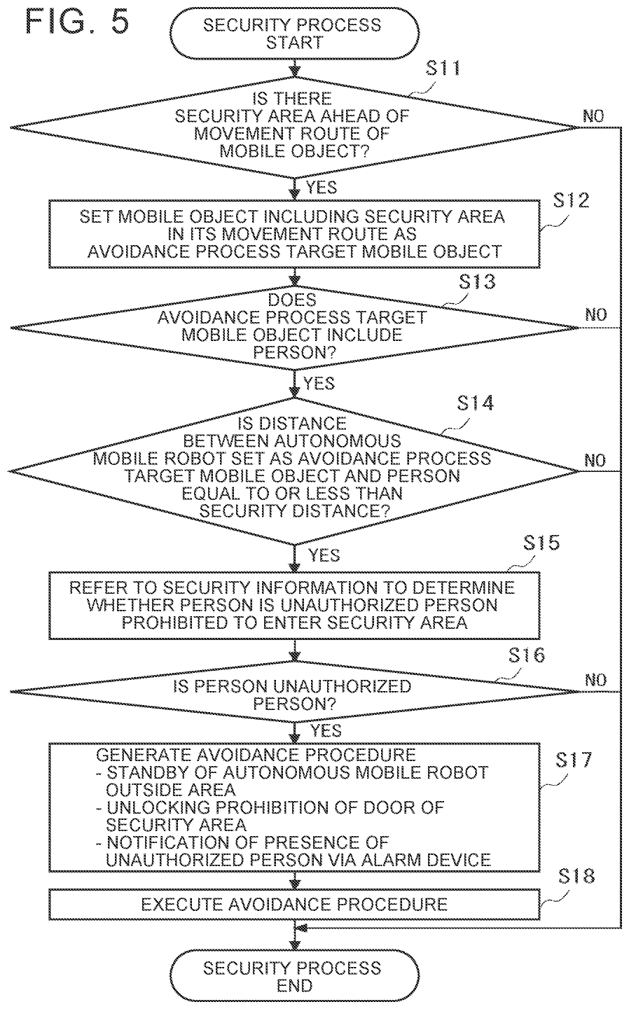

FIG. 5 shows a flowchart illustrating the detailed operation of the security process of the autonomous mobile robot control system according to the first embodiment. The security process is mainly performed using the avoidance procedure generation unit 115, the robot control unit 111, and the facility control unit 112.

In the security process, the avoidance procedure generation unit 115 performs a person determination process in steps S11 to S16. In step S11, a determination is made whether there is a security area ahead of the movement route of the mobile object. When the movement route of the mobile object does not include a security area in step S11, the autonomous mobile robot control system 1 terminates the security process. On the other hand, when a determination is made in step S11 that the movement route of the mobile object includes a security area, the avoidance procedure generation unit 115 sets the mobile object including the security area in its movement route as an avoidance process target mobile object (step S12).

After that, the avoidance procedure generation unit 115 determines whether a person is included in the avoidance process target mobile object (step S13). In step S13, when the avoidance process target mobile object does not include a person, the autonomous mobile robot control system 1 terminates the security process. On the other hand, in step S13, when a person is included in the avoidance process target mobile object, a determination is made whether the distance between the autonomous mobile robot 20 set as the avoidance process target mobile object and the person is equal to or less than a security distance that is set in advance as a distance that ensures safety (step S14). When the distance between the autonomous mobile robot 20 and the person is longer than the security distance in step S14, the autonomous mobile robot control system 1 terminates the security process, assuming that the safety of the security area is ensured. On the other hand, when a determination is made in step S14 that the distance between the autonomous mobile robot 20 and the person is equal to or less than the security distance, the avoidance procedure generation unit 115 refers to the security information (not shown in FIG. 1) to determine whether the person near the autonomous mobile robot 20 is permitted to enter the security area (steps S15 and S16).

When the person is determined to be an unauthorized person in step S16, the avoidance procedure generation unit 115 generates a measure of prohibiting entering the security area as an avoidance procedure (step S17). The avoidance procedure generated in step S17 includes, for example, standby of the autonomous mobile robot 20 outside the security area, an unlocking prohibition measure of the door of the security area, and a notification measure of the presence of an unauthorized person in the vicinity via the alarm device 31.

Thereafter, in the autonomous mobile robot control system 1, the robot control unit 111 gives a specific operation instruction to the autonomous mobile robot 20 based on the avoidance procedure generated in step S17, and the facility control unit 112 controls the alarm device 31 and the door (step S18).

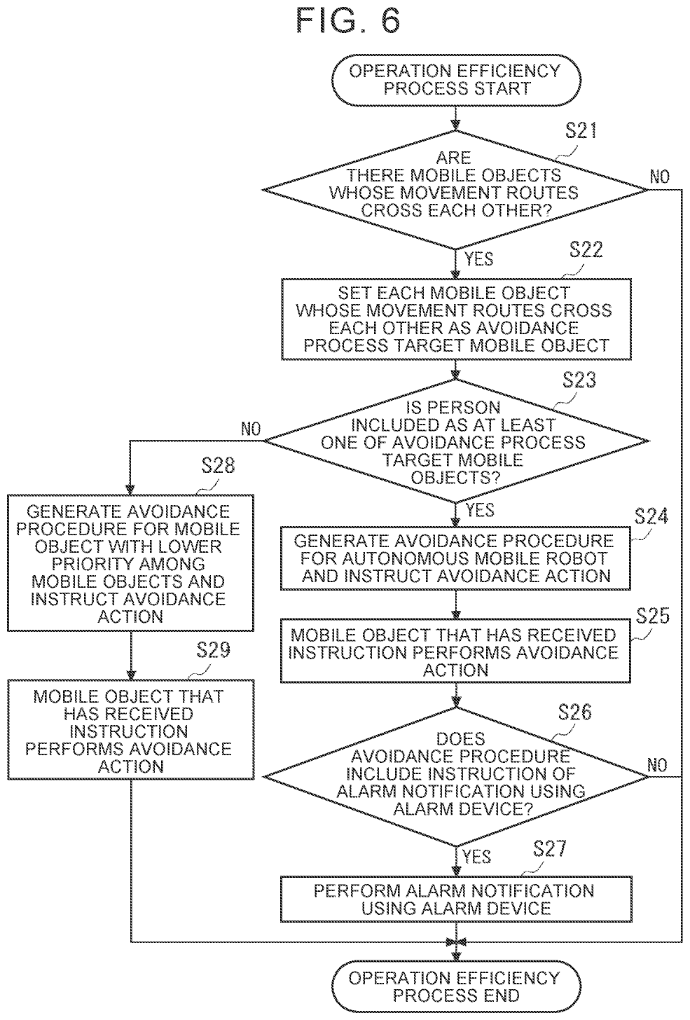

Next, the operation efficiency process will be described in detail. FIG. 6 shows a flowchart illustrating the detailed operation of the operation efficiency process of the autonomous mobile robot control system according to the first embodiment. The operation efficiency process is mainly performed using the avoidance procedure generation unit 115, the robot control unit 111, and the facility control unit 112.

As shown in FIG. 6, in the operation efficiency process, the avoidance procedure generation unit 115 determines whether there are mobile objects whose movement routes cross (overlap/intersect) each other (step S21). In step S21, when there are no mobile objects whose movement routes cross each other, the operation efficiency process is terminated. On the other hand, in step S21, when there are mobile objects whose movement routes cross each other, the avoidance procedure generation unit 115 sets each mobile object whose movement routes cross each other as an avoidance process target mobile object (step S22). After that, the avoidance procedure generation unit 115 determines whether a person is included as at least one of the avoidance process target mobile objects (step S23). Here, the case where the mobile object includes a person includes a case where a person who pushes the carrier and the priority carrier is included.

In step S23, when a person is included in the avoidance process target mobile object, the avoidance procedure generation unit 115 generates an avoidance procedure for the autonomous mobile robot 20, and the robot control unit 111 gives the autonomous mobile robot 20 the avoidance action instruction according to the avoidance procedure (step S24). As a result, the autonomous mobile robot 20 that has received the avoidance action instruction performs the avoidance action (step S25). When the avoidance procedure generated in step S24 includes an instruction of the alarm notification using the alarm device 31 (YES in step S26), the facility control unit 112 performs the alarm notification using the alarm device 31 according to the avoidance procedure (step S27). Further, when the avoidance procedure does not include the alarm notification using the alarm device 31 in step S26, the process ends without performing the alarm notification process in step S27.

In step S23, when the avoidance process target mobile object does not include a person, the avoidance procedure generation unit 115 generates the avoidance procedure for the mobile object with the lower priority among the mobile objects included in the avoidance process target mobile objects, and the robot control unit 111 gives an avoidance action instruction according to the avoidance procedure to the autonomous mobile robot 20 (step S28). As a result, the autonomous mobile robot 20 that has received the avoidance action instruction performs the avoidance action (step S29).

As described above, the autonomous mobile robot control system 1 according to the first embodiment detects in advance situations that pose problems in the operation of the autonomous mobile robot 20 based on the image information in the facility within the movement range of the autonomous mobile robot 20, and generates an avoidance procedure indicating a procedure for an avoidance action based on the detection result. By controlling the autonomous mobile robot 20 or the alarm device 31 according to the avoidance procedure, the operation efficiency of the autonomous mobile robot 20 can be improved.

Moreover, in the autonomous mobile robot control system 1 according to the first embodiment, by performing the security process described with reference to FIG. 5, unauthorized persons can be suppressed from entering the security area and thus the safety of the security area can be improved.

Furthermore, by acquiring an image including light reflection as the image information acquired by the environmental cameras 301 to 30n used in the autonomous mobile robot control system 1, for example, a table-clearing situation of a tray on a carrier that is used as a table-clearing rack can be grasped.

### Second Embodiment

Next, an autonomous mobile robot control system 1A according to the second embodiment will be described.

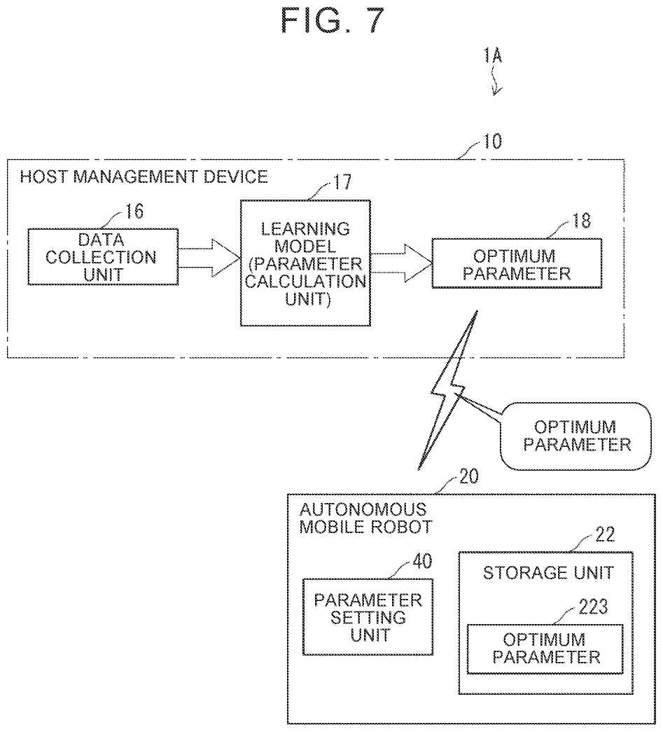

FIG. 7 is a schematic configuration diagram of an autonomous mobile robot control system 1A.

As shown in FIG. 7, the autonomous mobile robot control system 1A of the second embodiment mainly differs from the autonomous mobile robot control system 1 of the first embodiment in that the host management device 10 (for example, an information processing device such as a server) further includes a data collection unit 16 and a learning model 17 (an example of the parameter calculation unit of the present disclosure), and the communication unit 14 of the host management device 10 transmits the optimum parameters calculated by the learning model 17 to the autonomous mobile robot 20. Further, the autonomous mobile robot control system 1A of the second embodiment also differs from the autonomous mobile robot control system 1 of the first embodiment in that the communication unit 23 of the autonomous mobile robot 20 receives the optimum parameters, the autonomous mobile robot 20 further includes a parameter setting unit 40 for setting the received optimum parameters, and a predetermined operation is executed based on the optimum parameters set by the parameter setting unit 40. In the following, differences from the first embodiment will be mainly described, and the same reference signs will be assigned to the same configurations as in the first embodiment, and description thereof will be omitted as appropriate.

First, the configuration of the host management device 10 (the data collection unit 16 and the learning model 17) will be described.

The data collection unit 16 collects sunshine condition data corresponding to (related to) the sunshine condition within the movement range of the autonomous mobile robot 20 (for example, a first route R1, a second route R2, and a third route R3, which will be described later).

The sunshine condition data is an image (feature amount described later) obtained by photographing the movement range of the autonomous mobile robot 20, and includes, for example, an image obtained by photographing the first route R1, an image obtained by photographing the second route R2, and an image obtained by photographing the third route R3, which will be described later. The images are captured by the environmental cameras 301 to 30n. The images are hereinafter referred to as environmental camera images.

The environmental camera images are collected at predetermined timings. For example, one environmental camera image is collected every minute. The host management device 10 extracts (one or more) feature amounts from the environmental camera images by executing predetermined image processing on the collected environmental camera images.

The sunshine condition data includes date and time, time zone, weather, and temperature. The date and time and time zone are, for example, Internet time collected from the Internet (for example, an Internet time server). The Internet time is collected at predetermined timings. For example, the Internet time is collected every minute in accordance with the timing of collecting the environmental camera images.

The weather is the weather in the area where the facility (hospital in this case) where the autonomous mobile robot 20 is used is located. The weather is collected from specific websites, for example, by web scraping. The weather is collected at predetermined timings. For example, the weather is collected every 30 minutes.

The temperature is the temperature within the movement range of the autonomous mobile robot 20. The temperature is collected, for example, from Internet of Things (IoT) devices (including temperature sensors) installed in the movement range of the autonomous mobile robot 20. The temperature is collected at predetermined timings. For example, the temperature is collected every minute in accordance with the timing of collecting the environmental camera images.

The sunshine condition data collected by the data collection unit 16 as described above (for example, environmental camera images (feature amounts), date and time, time zone, weather, and temperature) is stored (accumulated) in the storage unit 12 of the host management device 10.

The sunshine condition data accumulated in the storage unit 12 as described above is input to a learning engine (artificial intelligence (AI) engine) as learning data every time a certain period of time (for example, one week or one year) passes.

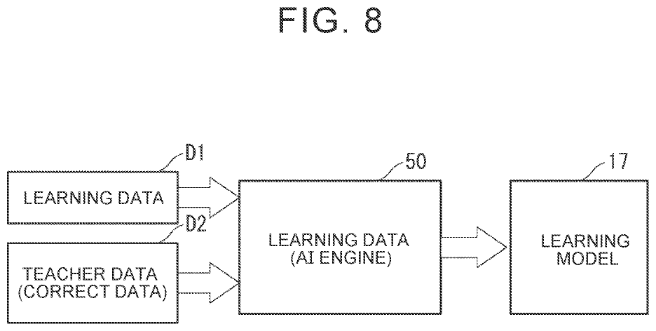

FIG. 8 is a schematic diagram illustrating an operation example of a learning engine 50.

As shown in FIG. 8, the learning engine 50 has learning data D1 and teacher data D2 (correct data) as inputs and a learning model 17 as an output. The learning engine 50 is, for example, scikit-learn or PyTorch. The learning data D1 is the sunshine condition data for a certain period accumulated in the storage unit 12 as described above. The teacher data D2 (correct data) are optimum parameters corresponding to the sunshine condition data.

The optimum parameter is a parameter considered so as to reduce the influence of the sunshine condition corresponding to the sunshine condition data.

For example, for the camera 25 (one example of a visible camera of the present disclosure), the optimum parameter is at least one of exposure time and shutter interval. In the case of a depth camera, which is one of the distance sensor group 24, the optimum parameter is a parameter of a filter (a filter that executes noise canceling processing on sensor data that is the output of the depth camera). In the case of a laser sensor, which is another one of the distance sensor group 24, the optimum parameter is a parameter of a filter (a filter that executes noise canceling processing on sensor data that is the output of the laser sensor).

These optimum parameters may be determined (set) by a person based on experience or the like so as to reduce the influence of the sunshine condition corresponding to the sunshine condition data, or may be automatically determined (set) by a predetermined program based on a predetermined algorithm.

For example, if sunlight can affect the output of the sensor device (for example, the camera 25, the depth camera, and the laser sensor) (for example, if the reflected light is too strong), the noise is considered higher than normal, so that it is conceivable to shorten the exposure time or adjust (set) the parameters in the direction of noise removal. On the other hand, when the possibility of sunlight affecting the sensor device (for example, the camera 25, the depth camera, and the laser sensor) is low (for example, when the reflected light is weak), it is conceivable to increase the exposure time or adjust (set) the parameters in the direction of noise non-removal (to use raw data as much as possible).

The learning model 17 is a learning result generated by the learning engine 50 (for example, machine learning). The learning model 17 has prediction target data as an input and a prediction result as an output. The prediction target data is, for example, the sunshine condition data. The prediction result is, for example, the optimum parameters corresponding to the sunshine condition data.

When the sunshine condition data is input, the learning model 17 calculates (outputs) the optimum parameters that reduce the influence of the sunshine condition corresponding to the sunshine condition data, based on the sunshine condition data and the learning result. The learning model 17 is an example of the parameter calculation unit of the present disclosure.

The calculation timing of the optimum parameters is, for example, after the route along which the autonomous mobile robot 20 should move is determined. At that time, the learning model 17 calculates the optimum parameter for each of the plurality of routes along which the autonomous mobile robot 20 moves.

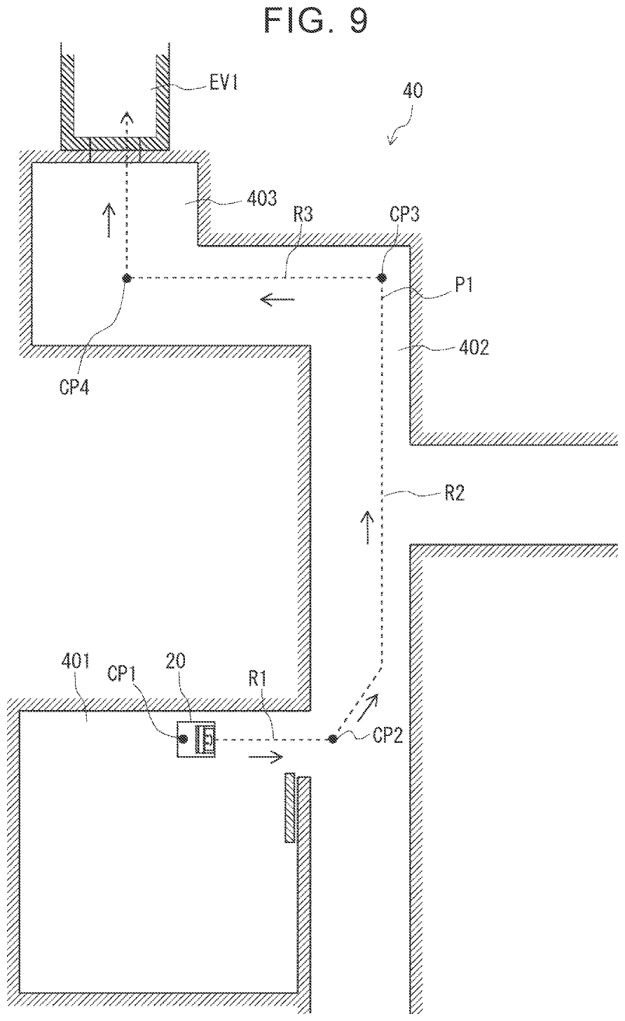

For example, as shown in FIG. 9, as the route along which the autonomous mobile robot 20 moves, a first route R1 from a position CP1 in a room 401 of a facility 40 (hospital in this case) to a position CP2 in a corridor 402, a second route R2 from the position CP2 in the corridor 402 to a position CP3, and a third route R3 from the position CP3 in the corridor 402 to a position CP4 in an elevator hall 403 in front of an elevator EV1 are determined. FIG. 9 is an example of the route along which the autonomous mobile robot 20 moves.

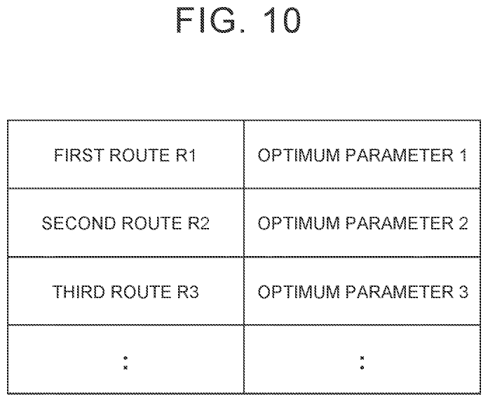

In this case, the learning model 17 calculates an optimum parameter for each of the routes R1, R2, and R3. FIG. 10 is an example of the optimum parameter for each route. These optimum parameters are transmitted to the autonomous mobile robot 20 in a state associated with the routes. The optimum parameters are received by the autonomous mobile robot 20 and stored in the storage unit 22 of the autonomous mobile robot 20.

Next, the configuration of the autonomous mobile robot 20 (parameter setting unit 40) will be described.

The parameter setting unit 40 sets the optimum parameters transmitted from the host management device 10.

When the optimum parameter set by the parameter setting unit 40 is the exposure time and the shutter interval, the camera 25 photographs the surroundings based on the optimum parameter (the exposure time and the shutter interval).

On the other hand, when the optimum parameter set by the parameter setting unit 40 is a parameter of a filter (a filter that executes noise canceling processing on sensor data that is the output of the depth camera), the autonomous mobile robot 20 executes the noise cancelling processing on the sensor data that is the output of the depth camera based on the optimum parameter (filter parameter). Similarly, when the optimum parameter set by the parameter setting unit 40 is a parameter of a filter (a filter that executes noise canceling processing on sensor data that is the output of the laser sensor), the autonomous mobile robot 20 executes the noise cancelling processing on the sensor data that is the output of the laser sensor based on the optimum parameter (filter parameter).

Next, an operation example of the autonomous mobile robot control system 1A having the above configuration will be described.

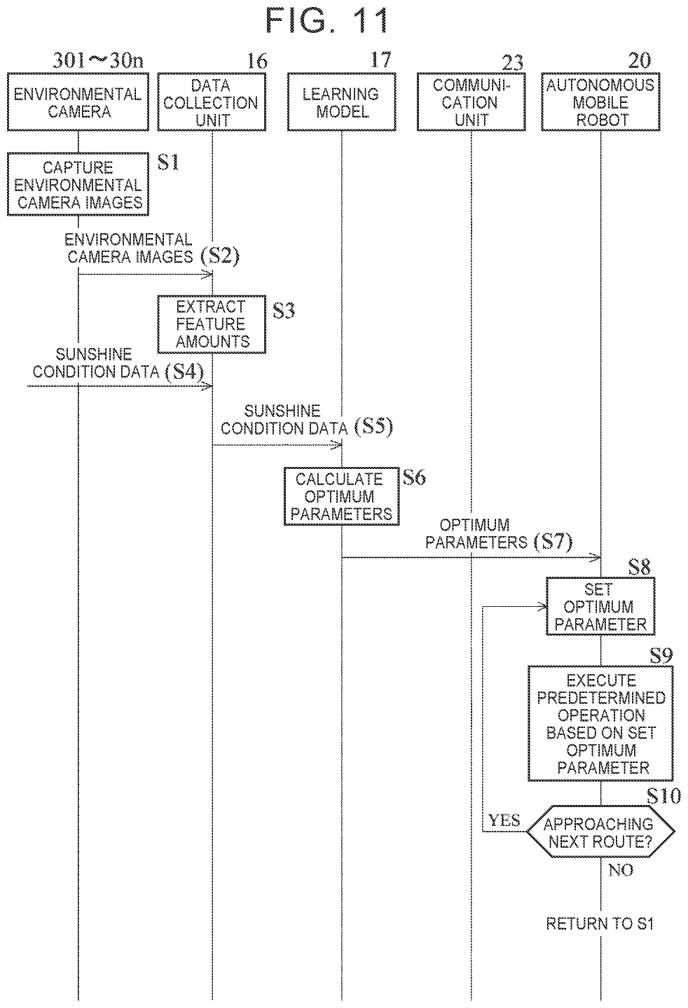

FIG. 11 is a flowchart of an operation example of the autonomous mobile robot control system 1A.

The following describes an example in which, as shown in FIG. 9, the route along which the autonomous mobile robot 20 moves is the first route R1 from the position CP1 in the room 401 of the facility 40 (hospital in this case) to the position CP2 in the corridor 402, the second route R2 from the position CP2 in the corridor 402 to the position CP3, and the third route R3 from the position CP3 in the corridor 402 to the position CP4 in the elevator hall 403 in front of the elevator EV1.

The environmental cameras 301 to 30n capture images (environmental camera images) of the respective ranges (for example, the first route R1, the second route R2, and the third route R3) at predetermined timings (step S1). The captured environmental camera images are transmitted from the environmental cameras 301 to 30n to the data collection unit 16 (step S2).

The data collection unit 16 collects (receives) the environmental camera images transmitted from the environmental cameras 301 to 30n.

Next, the host management device 10 executes predetermined image processing on each of the collected environmental camera images to extract (one or more) feature amounts from each of the environmental camera images (step S3).

The data collection unit 16 also collects the sunshine condition data (for example, current date and time, time zone, weather, and temperature) from the Internet or the like (step S4).

The sunshine condition data (environmental camera images (feature amounts), current date and time, time zone, weather, and temperature) collected as described above are input to the learning model 17 (step S5).

When the sunshine condition data is input, the learning model 17 calculates the optimum parameters that reduce the influence of the sunshine condition corresponding to the sunshine condition data, based on the sunshine condition data and the learning result (step S6). At that time, as shown in FIG. 10, the learning model 17 calculates the optimum parameter (here, the optimum parameter 1, the optimum parameter 2, and the optimum parameter 3) for each of the plurality of routes (here, the first route R1, the second route R2, and the third route R3).

Next, the host management device 10 (communication unit 14) transmits the optimum parameters (see FIG. 10) calculated in step S6 to the autonomous mobile robot 20 (step S7).

The autonomous mobile robot 20 (communication unit 23) receives the optimum parameters transmitted from the host management device 10 (communication unit 14). These optimum parameters are stored in the storage unit 22 of the autonomous mobile robot 20. A reference sign 223 in FIG. 7 represents the optimum parameters stored in the storage unit 22 in this way. Hereinafter, it is described as the optimum parameter 223.

Next, the parameter setting unit 40 reads the optimum parameter (here, the optimum parameter 1) associated with the route corresponding to the current location of the autonomous mobile robot 20 (here, the first route R1) among the optimum parameters 223 from the storage unit 22 and sets the optimum parameter (step S8).

Then, the autonomous mobile robot 20 executes a predetermined operation based on the optimum parameter (here, the optimum parameter 1) set by the parameter setting unit 40 (step S9).

The predetermined operation is, for example, an operation of photographing the surroundings with the camera 25 based on the optimum parameter set in step S8, an operation of executing noise canceling processing on sensor data that is the output of the depth camera based on the optimum parameter (filter parameter) set in step S8, and an operation of executing noise canceling processing on sensor data that is the output of the laser sensor based on the optimum parameter (filter parameter) set in step S8.

This can suppress detection variations of the sensor device (for example, the camera 25, the depth camera, and the laser sensor) provided in the autonomous mobile robot 20 from increasing due to the sunshine condition within the movement range (here, the first route R1) of the autonomous mobile robot 20. As a result, it is possible to suppress the recognition rate from decreasing and the self-position accuracy from decreasing due to the sunshine condition within the movement range (here, the first route R1) of the autonomous mobile robot 20.

Next, when the autonomous mobile robot 20 is not approaching the next route (here, the second route R2) (step S10: NO), that is, when the distance to the next route exceeds a threshold, the process returns to step S1 and the processes of step S1 and after are repeatedly executed.

On the other hand, when the autonomous mobile robot 20 travels autonomously and approaches the next route (here, the second route R2) (step S10: YES), that is, when the distance to the next route is equal to or less than the threshold, the parameter setting unit 40 reads the optimum parameter (here, the optimum parameter 2) associated with the next route (here, the second route R2) among the optimum parameters 223 from the storage unit 22 and sets the optimum parameter (step S8).

Then, the autonomous mobile robot 20 performs the above predetermined operation based on the optimum parameter (here, the optimum parameter 2) set by the parameter setting unit 40 (step S9).

This can suppress detection variations of the sensor device (for example, the camera 25, the depth camera, and the laser sensor) provided in the autonomous mobile robot 20 from increasing due to the sunshine condition within the movement range (here, the second route R2) of the autonomous mobile robot 20. As a result, it is possible to suppress the recognition rate from decreasing and the self-position accuracy from decreasing due to the sunshine condition within the movement range (here, the second route R2) of the autonomous mobile robot 20. Also, it is possible to automatically set an optimum parameter suitable for the sunshine condition of the next route before the autonomous mobile robot 20 reaches (enters) the next route (here, the second route R2).

Next, when the autonomous mobile robot 20 is not approaching the next route (here, the third route R3) (step S10: NO), that is, when the distance to the next route exceeds the threshold, the process returns to step S1 and the processes of step S1 and after are repeatedly executed.

On the other hand, when the autonomous mobile robot 20 travels autonomously and approaches the next route (here, the third route R3) (step S10: YES), that is, when the distance to the next route is equal to or less than the threshold, the parameter setting unit 40 reads the optimum parameter (here, the optimum parameter 3) associated with the next route (here, the third route R3) among the optimum parameters 223 from the storage unit 22 and sets the optimum parameter (step S8).

Then, the autonomous mobile robot 20 performs the above predetermined operation based on the optimum parameter (here, the optimum parameter 3) set by the parameter setting unit 40 (step S9).

This can suppress detection variations of the sensor device (for example, the camera 25, the depth camera, and the laser sensor) provided in the autonomous mobile robot 20 from increasing due to the sunshine condition within the movement range (here, the third route R3) of the autonomous mobile robot 20. As a result, it is possible to suppress the recognition rate from decreasing and the self-position accuracy from decreasing due to the sunshine condition within the movement range (here, the third route R3) of the autonomous mobile robot 20. Also, it is possible to automatically set an optimum parameter suitable for the sunshine condition of the next route before the autonomous mobile robot 20 reaches (enters) the next route (here, the third route R3).

As described above, according to the second embodiment, detection variations of the sensor device (for example, the camera 25, the depth camera, and the laser sensor) provided in the autonomous mobile robot 20 can be suppressed from increasing due to the sunshine condition within the movement range of the autonomous mobile robot 20.

This is because the autonomous mobile robot control system is provided with the learning model 17 that calculates, based on the sunshine condition data and the learning result, optimum parameters that reduce the influence of the sunshine condition corresponding to the sunshine condition data, and the autonomous mobile robot 20 executes the above predetermined operation based on the optimum parameters.

Next, a modification will be described.

In the second embodiment, an example of generating the learning model 17 by supervised learning has been described, but the present disclosure is not limited to this. For example, the learning model 17 may be generated by a technique other than supervised learning, such as reinforcement learning. When reinforcement learning is used, it is conceivable to set a higher reward as the time required for the autonomous mobile robot 20 to move along a route (route travel) is shortened, and to cause the learning model 17 to learn a policy for determining parameters for each passage. This is based on the hypothesis that the autonomous mobile robot 20 to which inappropriate parameters are set picks up unnecessary information in sensing, or cannot obtain necessary information, resulting in a longer traveling time.

All the numerical values shown in the above embodiments are examples, and it is of course possible to use other appropriate numerical values.

Each embodiment described above is only a mere illustration in all respects. The present disclosure is not limitedly interpreted by the description of the above embodiments. The present disclosure can be embodied in various other forms without departing from its spirit or essential characteristics.

What is claimed is:

1. An autonomous mobile robot control system comprising:
a host management device; and
an autonomous mobile robot, wherein:
the host management device includes
a data collection unit that collects sunshine condition data corresponding to a sunshine condition within a movement range of the autonomous mobile robot,
a parameter calculation unit that calculates, based on the sunshine condition data, an optimum parameter that reduces an influence of the sunshine condition corresponding to the sunshine condition data, and
a communication unit that transmits the optimum parameter to the autonomous mobile robot;
the autonomous mobile robot includes
a communication unit that receives the optimum parameter, and
a parameter setting unit that sets the optimum parameter; and
the autonomous mobile robot control system executes a predetermined operation based on the optimum parameter set by the parameter setting unit.

2. The autonomous mobile robot control system according to claim 1, further comprising a plurality of environmental cameras that captures images of the movement range of the autonomous mobile robot and transmits the captured images to the host management device, wherein the sunshine condition data includes the images.

3. The autonomous mobile robot control system according to claim 2, wherein the sunshine condition data further includes date and time, time zone, weather, and temperature.

4. The autonomous mobile robot control system according to claim 1, wherein:
the autonomous mobile robot includes a visible camera that captures an image of surroundings;
the optimum parameter is at least one of exposure time and shutter interval; and
the predetermined operation is an operation of capturing the image of the surroundings with the visible camera based on the optimum parameter set by the parameter setting unit.

5. The autonomous mobile robot control system according to claim 1, wherein:
the autonomous mobile robot includes a distance sensor;
the optimum parameter is a parameter of a filter that executes noise canceling processing on sensor data that is an output of the distance sensor; and
the predetermined operation is an operation of executing the noise canceling processing on the sensor data that is the output of the distance sensor based on the optimum parameter set by the parameter setting unit.

6. The autonomous mobile robot control system according to claim 5, wherein the distance sensor is a depth camera or a laser sensor.

7. The autonomous mobile robot control system according to claim 1, wherein:
the parameter calculation unit calculates the optimum parameter for each of a plurality of routes along which the autonomous mobile robot moves; and
the parameter setting unit sets, when the autonomous mobile robot approaches one of the routes, the optimum parameter corresponding to the route.

8. The autonomous mobile robot control system according to claim 1, wherein the parameter calculation unit is a learning model generated by a learning engine.

9. An autonomous mobile robot control method comprising:
a data collection step in which a host management device collects sunshine condition data corresponding to a sunshine condition within a movement range of an autonomous mobile robot;
a parameter calculation step in which the host management device calculates, based on the sunshine condition data, an optimum parameter that reduces an influence of the sunshine condition corresponding to the sunshine condition data; and
a communication step in which the host management device transmits the optimum parameter to the autonomous mobile robot.

10. An autonomous mobile robot control method comprising:
a communication step in which an autonomous mobile robot receives an optimum parameter;
a parameter setting step in which the autonomous mobile robot sets the optimum parameter; and
a step in which the autonomous mobile robot executes a predetermined operation based on the set optimum parameter.
